(19) United States
(12) Patent Application Publication
(10) Pub. No.: US 2005/0184011 A1
(43) Pub. Date: Aug. 25, 2005

(54) Car wash water reclamation system

(76) Inventor: William Michael Fields, Highlands Ranch, CO (US)

Correspondence Address: PATTON BOGGS, 1660 LINCOLN ST, SUITE 2050, DENVER, CO, 80264, US

(21) Appl. No.: 10/783,828

(22) Filed: Feb. 20, 2004

(51) Int. Cl. C02F 1/78

(52) U.S. Cl. 210/748; 210/760; 210/192; 210/202

(57) ABSTRACT

The car wash water reclamation system treats car wash wastewater that is contaminated with sediment, odors and bacteria so the water can be reclaimed and recycled through the car wash system for reuse. The car wash reclamation system uses a multi-step process to first remove odors and bacteria from the car wash wastewater, then remove heavy sand and grit, prior to final filtration to remove the small diameter particulate matter from the car wash wastewater. Upon completion of the entire cycle, the treated wastewater is clean enough to be reclaimed and used again in the car wash.

### FIELD OF THE INVENTION

This invention relates generally to the treatment of wastewater and more particularly to a car wash water reclamation system that removes undesirable matter from car wash wastewater to enable the reuse of the treated wastewater.

### PROBLEM

It is a problem in the field of wastewater treatment that there are many instances where it is necessary to remove a sufficient amount of undesirable particulate matter as well as bacteria and odors from wastewater to enable the reuse of the wastewater for a particular purpose. One such instance relates to the treatment of car wash wastewater in order to reclaim the water for reuse in the car wash.

In many parts of the world, water is a precious and scarce resource and should not be wasted. Millions of gallons of car wash wastewater go down the drain every day, much of which could and should be reclaimed, cleaned up and used again. While some car wash enterprises reclaim and reuse their wastewater, they typically use a bag filter system that does not clean the wastewater, it only filters particulate matter from the wastewater. A typical bag filter water reclamation system cycles the car wash wastewater through a series of mesh bags, where the particulate matter in the wastewater: dirt, sediment and sand, are trapped in the mesh bags. There are three problems with this bag filter water reclamation system: 1) It is labor intensive—the mesh bags have to be frequently taken down, emptied and the sediment discarded; 2) It is expensive—the mesh bags are costly, they wear out and/or split and have to be replaced frequently; and, 3) It doesn't remove bacterial and odor contaminants—they remain in the treated water.

Thus, there remains a need for an efficient and economical water reclamation system to not only remove sediment from car wash wastewater but to also remove bacterial and odor contaminants from the car wash wastewater.

### SOLUTION

The above described problems are solved and a technical advance achieved in the art by the present car wash water reclamation system which treats car wash wastewater that is contaminated with sediment, odors and bacteria so the water can be reclaimed and recycled through the car wash system for reuse. The/car wash reclamation system uses a multi-step process to first remove odors and bacteria from the car wash wastewater, then remove heavy sand and grit, prior to final filtration to remove the small diameter particulate matter from the car wash wastewater. Upon completion of the entire cycle, the treated wastewater is clean enough to be reclaimed and used again in the car wash.

In a typical implementation of this car wash water reclamation system, a sump pump draws a stream of contaminated car wash wastewater from the top of an existing sump pit (underground wastewater process tank) into the car wash water reclamation system via an inlet connection. Ambient air is simultaneously drawn through an air filter into an ionizer cell where ozone is generated using an ultraviolet lamp. Using negative pressure, a Venturi extracts the ozone from the ionizer and injects it into the stream of contaminated wastewater to destroy odors and bacteria in the wastewater. The ozone-treated wastewater is then pumped through one or more cyclone mixer/cleaners that separate out particulate matter (the heavier sand and grit) from the wastewater and also mix the ozone into the wastewater to destroy any remaining bacteria and/or other organic contaminants prior to final filtration. The extracted sand and grit are drained from the bottom of the cyclone mixer/cleaners into an existing external waste tank or floor drain.

The pre-filtered water passes from the cyclone mixer/cleaners into a process tank, operating at atmospheric pressure, and a filter feed pump pumps the pre-filtered water into a electrostatic filter tank that contains a glass bead media that is layered over a bed of gravel. An electric charge is applied to the glass bead media to cause particles as small as one micron to be electrostatically attracted to the glass beads as the pre-filtered water passes through the glass bead media. The filtered water then flows into small laterals in the bottom of the electrostatic filter tank and exits the electrostatic filter tank into a clean water holding tank. The cleaned water entering the clean water holding tank has now been ozonated, cleaned and filtered and is ready to use again in the car wash.

An automatic backwash cycle periodically reverses the flow of water through the electrostatic filter tank to flush out the small particles, rejuvenating the glass bead media. To conserve space, the entire car wash water reclamation system apparatus is mounted atop the clean water holding tank. The car wash uses its high-pressure pump to draw the cleaned water from the clean water holding tank for delivery to the existing piping of the car wash spray system. In addition, a connection to the municipal water line is provided so that city water can be used for the filter-cleaning backwash cycle, the final car rinse and to replace water loss due to evaporation and/or spillage. Municipal water use is still minimal compared to that used in most car wash systems.

Once installed and adjusted, the car wash water reclamation system operates automatically and should not require further manual operation of any kind. Routine maintenance of the system will assure satisfactory operation for a long time.

### BRIEF DESCRIPTION OF THE DRAWINGS

FIG. 1 illustrates a front elevation view of the car wash water reclamation system;

FIG. 2 illustrates a perspective view of the ionizer/Venturi/dual cyclone mixer/cleaner;

FIG. 3 illustrates a cross section view of the electrostatic filter assembly; and

FIGS. 4 & 5 illustrate, in flow diagram form, the operation of the present car wash water reclamation system.

### DETAILED DESCRIPTION

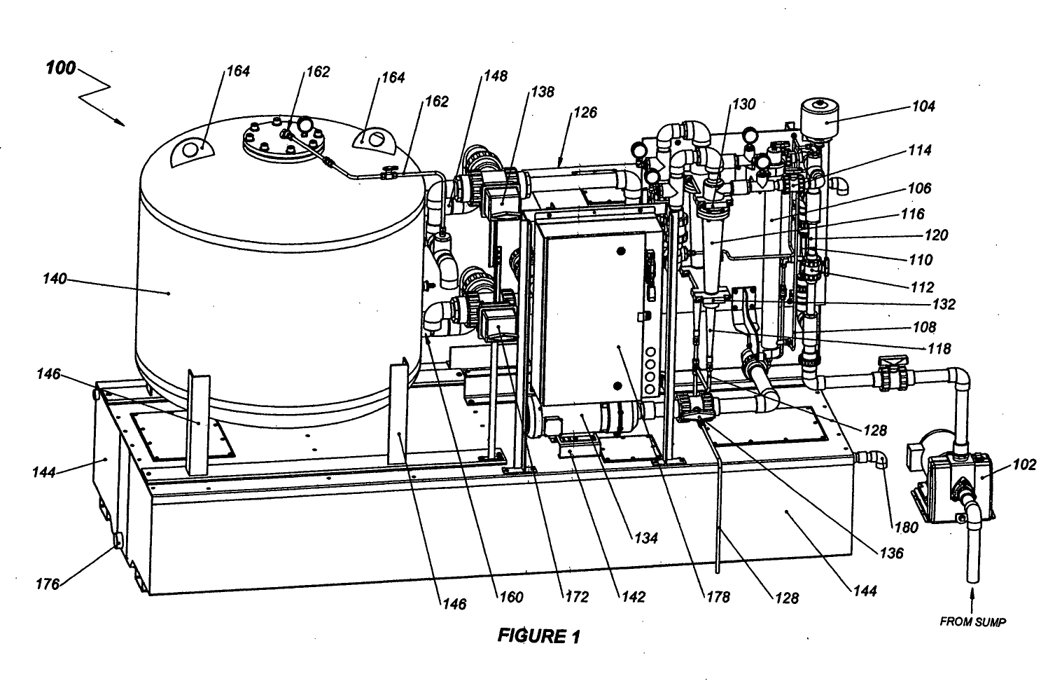

The present car wash water reclamation system 100 is illustrated in FIG. 1 and comprises an ozone system for destroying odors and bacteria contained in the car wash wastewater, two cyclone mixer/cleaners to separate out the heavier sediment and sand from the wastewater and a electrostatic filter tank where fine particles are removed from the pre-filtered water.

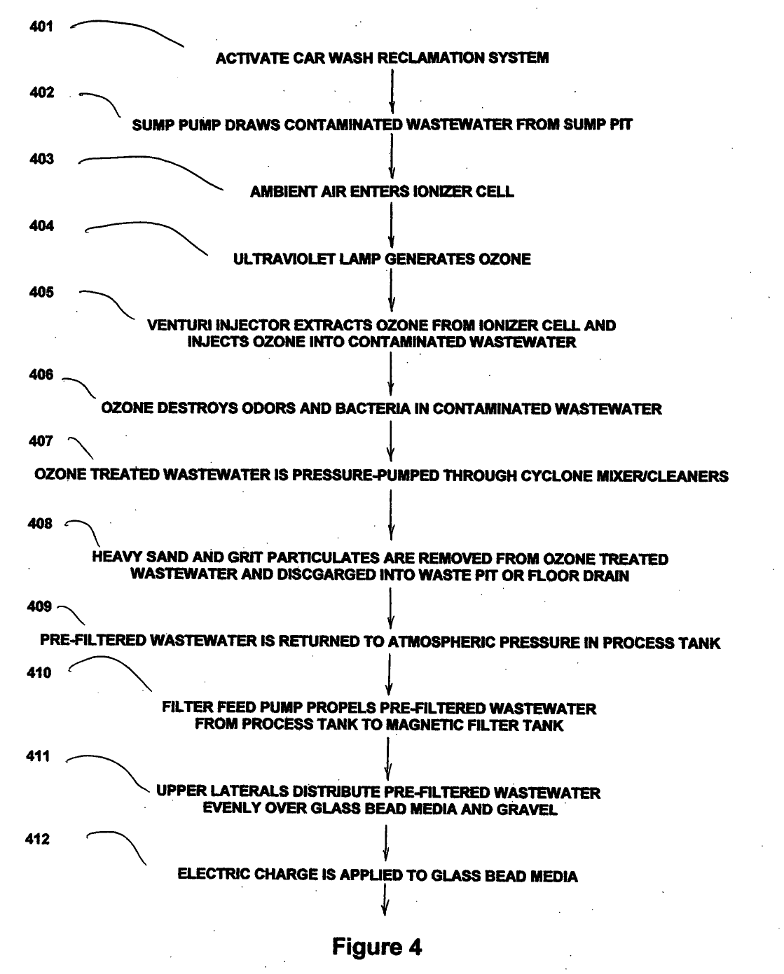

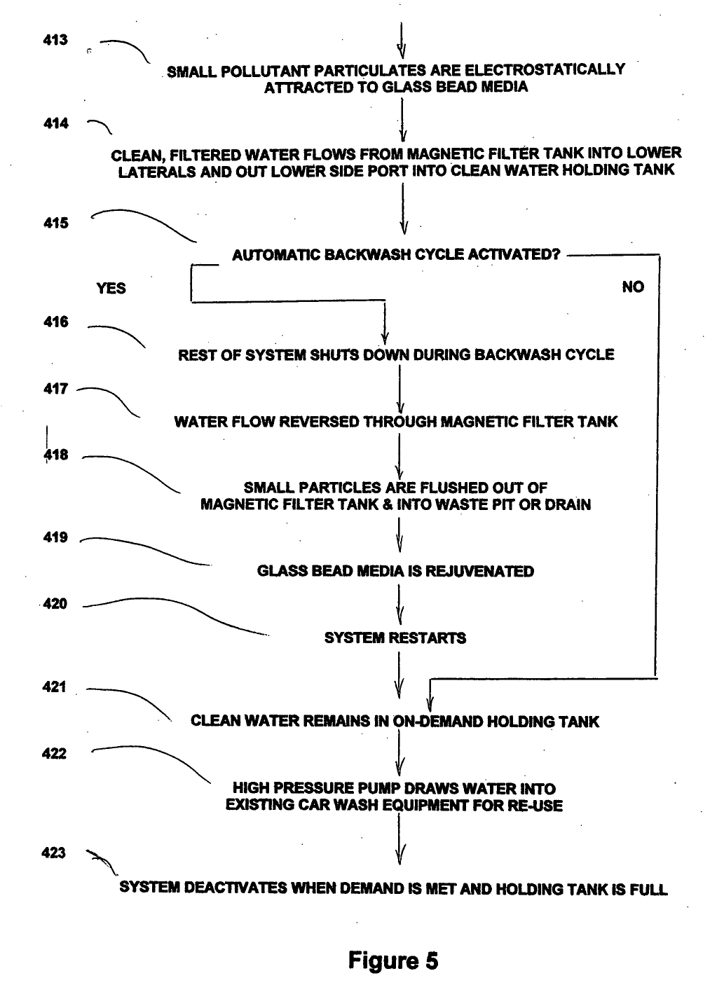

FIG. 1 illustrates a front elevation view of the car wash water reclamation system and FIGS. 4 & 5 illustrate, in flow diagram form, the operation of the present car wash water reclamation system. This car wash water reclamation system is activated at step 401, and at step 402 the contaminated car wash wastewater from an existing sump pit (not shown) is introduced into the ozone system via a self-priming sump pump 102. At step 403, ambient air is drawn through an air filter 104 and into a gas ionizer cell 106 where ozone is generated. The ionizer cell comprises a tubular, stainless steel housing and an inner pipe of appropriate length for housing an ultraviolet lamp having a wavelength of, for example, 185 nanometers. The ultraviolet waves output by the ultraviolet lamp react with the ambient air that passes through the ionizer cell 106 to produce ozone at step 404. The purpose of the dual shells (housing and inner pipe) is for cooling the apparatus. The ultraviolet lamp is held in place by a mounting assembly with a top bracket and a bottom bracket, each secured to the car wash water reclamation apparatus by suitable means. A top end cap protects the UV lamp and secures a UV lamp wire harness. For larger applications or when high concentration ozone is required, optional dual ultraviolet lamps and/or an oxygen generator may be introduced.

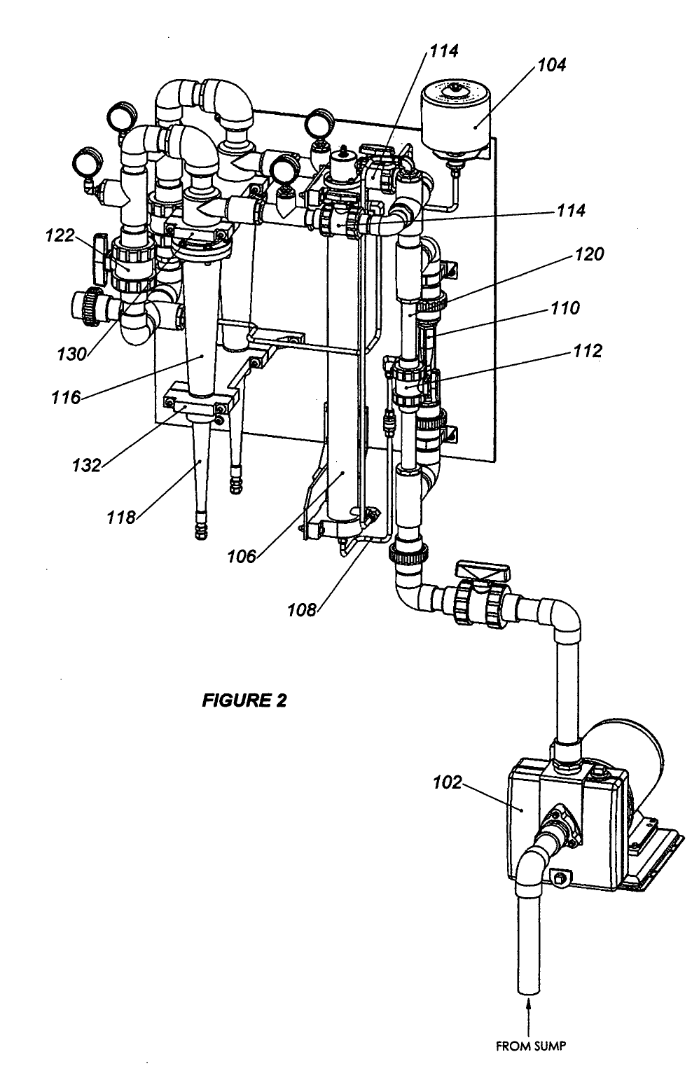

FIG. 2 illustrates a perspective view of the ionizer/Venturi/dual cyclone mixer/cleaner. Tubing 108 delivers the ozone from the ionizer cell 106 to a Venturi 110 which is connected to the pressurized outlet piping 120 from the sump pump 102 in a bypass configuration. The flow of pressurized wastewater from the sump pump 102 through Venturi 110 creates a pressure differential, causing a suction to extract ozone out of the ionizer cell and through the tubing 108. The extracted ozone is injected by the Venturi 110 into the stream of wastewater at step 405 to destroy odors and bacteria at step 406.

The ozone-treated wastewater is then pressure-forced, typically at up to 60 pounds per square inch (PSI), through dual cyclone mixer/cleaners 116 at step 407 via a valve 114 at the top of the mixing chamber. In order to maintain required flow through the cyclone mixer/cleaners 116, the ozone treated wastewater can be divided into two streams. The ozone-treated wastewater moves through an insert into the center tapered section of each cyclone mixer/cleaner 116 and, finally, to the nozzle end 118 at the bottom of each cyclone mixer/cleaner 116 to remove the particulate matter from the ozone treated wastewater at step 408. The cyclone mixer/cleaners 116 separate out the heavier sand and grit (to approximately ten microns) and thoroughly mix the ozone into the wastewater to destroy any remaining odor and/or bacteria, producing what is termed pre-filtered wastewater herein. Valves 114 on the inlet piping to the cyclone mixer/cleaners 116 provide for manual control of water pressure for the ozone treated wastewater entering the cyclone mixer/cleaners 116 and valves 122 on the outlet piping of the cyclone mixer/cleaners 116 provide for manual control of water pressure for the pre-filtered wastewater exiting the cyclone mixer/cleaners 116.

The pre-filtered wastewater from the cyclone mixer/cleaners 116 passes through a pipe into a process tank 126 at step 409 where the ozone continues to work on the pre-filtered wastewater to destroy contaminants and the pre-filtered wastewater is returned to atmospheric pressure. The particulate matter filtered from the ozone treated wastewater is removed from the cyclone mixer/cleaners 116, through a drain assembly 128 located at the bottom (nozzle end) of the cyclone mixer/cleaners 116, into an existing floor drain or waste tank (not shown). The cyclone mixer/cleaners 116 are secured to each other and to the car wash reclamation apparatus by a top bracket with end cap 130 and a bottom bracket with end cap 132.

The process tank 126 receives the pre-filtered water from the cyclone mixer/cleaners 116, thereby allowing the cyclone mixer/cleaners to operate at atmospheric pressure. A centrifugal filter feed pump 134 extracts the pre-filtered wastewater from the bottom of the process tank 126 at step 410 and discharges the pre-filtered wastewater through an electric three-way valve assembly 138 into the top of a electrostatic filter tank 140, which is typically manufactured from stainless steel. The filter feed pump 134 is secured to a base assembly 142 and installed by suitable means onto the top cover of a clean water base holding tank 144.

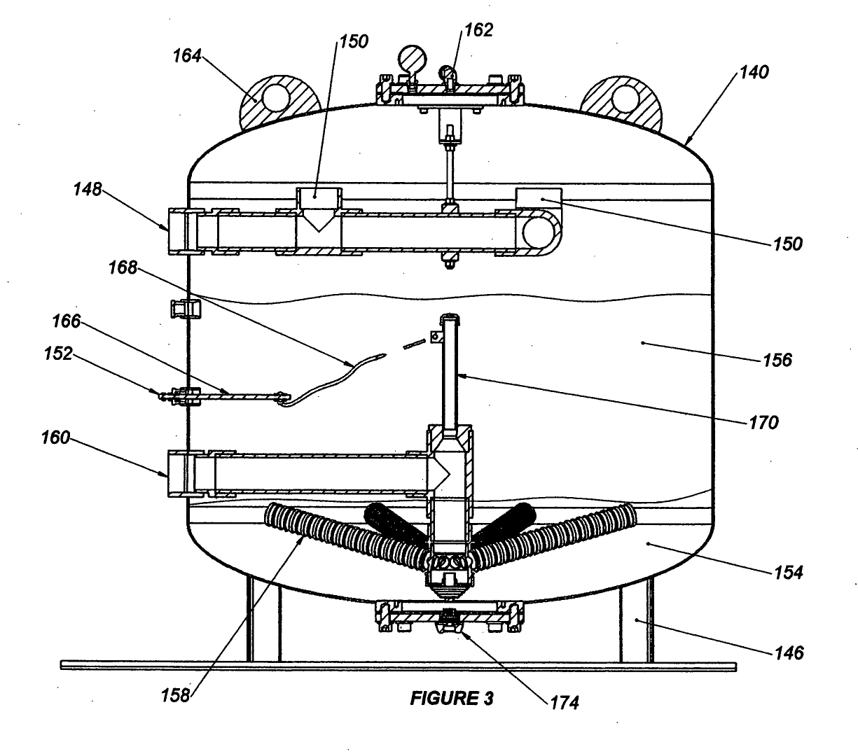

FIG. 3 illustrates a cross section view of the electrostatic filter assembly. As shown in FIG. 3, the electrostatic filter tank 140 comprises a stainless steel tank with a stand 146, an inlet port 148, upper distribution laterals 150, a magnetic electrode assembly 152, layers of gravel 154 and glass bead media 156, lower laterals 158, an outlet port 160 and a depressurization line 162. The electrostatic filter tank 140 is fitted with dual lifting lugs 164 welded onto the top to accommodate placement of the heavy electrostatic filter tank 140 onto the stand 146 without damaging it. The size of the electrostatic filter tank 140 can be varied according to the requirements of the application.

The upper distribution laterals 150 serve a dual purpose. As the pre-filtered wastewater enters the inlet port 148 at the top of the electrostatic filter tank 140, the upper laterals 150 at step 411 evenly distribute the pre-filtered wastewater over the surface of the glass bead media 156. During the automatic backwash cycle, the upper laterals 150 help prevent the glass bead media 156 from being washed out of the electrostatic filter tank 140 as the flow of water is reversed—entering through the lower laterals 158 and exiting through the upper laterals 150 carrying the collected pollutants out the top through the three-way electric valve assembly 138 and into an existing waste tank.

As the pre-filtered wastewater enters through the inlet port 148 and flows over the upper distribution laterals 150, an electric charge is applied to the glass bead media 156 at step 412 through a magnetic electrode assembly 152 comprising a threaded rod assembly 166, a stainless steel cable assembly 168, and a magnetic electrode 170. The electric charge causes fine particles, as small as one micron, suspended in the pre-filtered wastewater to be electrostatically attracted to the glass bead media 156 at step 413. The filtered water then flows through a plurality of laterals 158 in the bottom of the electrostatic filter tank 140 and exits at step 414 out a lower side port outlet 160 into a second electric three-way ball valve with actuator 172, through additional piping into a clean water holding tank 144. To allow for manual drainage of the electrostatic filter tank 140, a two-way stainless steel valve with handle 174 is installed at the bottom cover plate of the electrostatic filter tank 140.

The material for filtration is layered in the bottom of the electrostatic filter tank 140. The first layer on the bottom is gravel 154 at a typical depth of 8″ to 12″ and covers the lower laterals 158. The next layer on top of the gravel 154 is the glass bead media 156 for fine filtration. Normal depth of the glass bead media 156 is 20″ to 24″. The depth of the glass bead media 156 varies depending on the head height of the electrostatic filter tank 140. A depressurization line 162 extending from the top of the electrostatic filter tank 140 to the outlet port 160 keeps pressure from building in the electrostatic filter tank 140 and handles any resulting overflow spray occurring during the filtration cycle.

At step 415, the system determines whether it is time to activate an automatic backwash cycle. If not, processing advances to step 421 as described below. If the automatic backwash cycle is activated, typically by differential pressure of about 10 pounds per square inch (PSI), at step 416 the remainder of the car wash reclamation system 100 shuts down and at step 417 the system reverses the flow of water through the electrostatic filter tank 140. This reverse flow of water flushes out the small particles through the upper lateral assembly 150 and out the top of the electrostatic filter tank 140 through the three-way electric valve assembly 138 and into an existing waste tank at step 418. This process rejuvenates the glass bead media 156 at step 419. If a specific process application requires it, the backwash cycle can be set for a timed cycle rather than activated by pressure. Since very little water is required for the backwash cycle, clean city water can be used. The backwash cycle takes approximately two (2) minutes. Following the backwash cycle, the car wash reclamation system 100 at step 420 restarts and continues reclaiming water used during normal car wash operation at step 421.

The water remains in the clean water holding tank 144 until drawn by an existing, external high-pressure pump (not shown) into the existing car washing equipment for re-use at step 422. A suction manifold (not shown) is installed inside the end wall of the clean water holding tank 144 to prevent the water from creating a vortex when the high-pressure pump is activated to draw water out of the clean water holding tank 144. A “T” valve (not shown) connecting the back side of the lower 3-way valve assembly to the car wash's municipal water line allows for use of municipal water for the final rinse and for replacement of water loss due to evaporation and/or spillage. A system outlet 176 from the clean water holding tank 144 is attached to the piping of the existing car wash spray system.

The car wash water reclamation system 100 operates only when the water level in the clean water holding tank 144 is between the minimum and maximum set points. The car wash water reclamation system 100 is controlled by a programmable logic control (PLC) that deactivates the system when demand is met and the clean water holding tank 144 is full at step 423.

Summary

The car wash reclamation system uses a multi-step process to first remove odors and bacteria from the car wash wastewater, then remove heavy sand and grit, prior to final filtration to remove the small diameter particulate matter from the car wash wastewater. Upon completion of the entire cycle, the treated wastewater is clean enough to be reclaimed and used again in the car wash.

1. A water reclamation system for removing odors, bacteria and particulates from a flow of wastewater to produce clean water for re-use, comprising:
ozone generator means for ozonating a flow of wastewater to remove odors and bacteria;
particulate filtering means for pre-filtering said flow of ozone treated wastewater by separating heavier particulates out of said wastewater;
electrostatic filter means for electrostatically filtering said flow of pre-filtered wastewater to remove finer particulates; and
clean water holding tank means for storing cleaned water received from said electrostatic filter means for re-use.

2. The water reclamation system of claim 1 wherein said ozone generator means comprises:
an air filter for mechanically removing particulates from ambient air;
ionizer means for converting oxygen, contained in a flow of said filtered ambient air, into ozone to produce ionized, filtered air; and
mixing means for injecting said ionized, filtered air into said flow of wastewater to remove odors and bacteria.

3. The water reclamation system of claim 2 wherein said ionizer means comprises:
ultraviolet lamp means for exposing said flow of said filtered ambient air to ultraviolet light to convert oxygen contained in a flow of said filtered ambient air into ozone.

4. The water reclamation system of claim 2 wherein said mixing means comprises:
a Venturi that creates a pressure differential causing a suction to extract the ozone from said ionizer means and inject the ozone into said flow of wastewater.

5. The water reclamation system of claim 1 wherein said particulate filtering means comprises:
a cyclone mixer/cleaner to remove heavier particulates from said flow of ozone treated wastewater.

6. The water reclamation system of claim 5 further comprising:
a process tank wherein said ozone treated wastewater is returned to atmospheric pressure and ozone continues to work to destroy odors and bacteria.

7. The water reclamation system of claim 6 further comprising:
a filter feed pump to mechanically pump said ozone treated wastewater out of said process tank and into said electrostatic filter means.

8. The water reclamation system of claim 1 wherein said electrostatic filter means comprises:
a filter tank having input and output ports;
a layer of gravel distributed in the bottom of said filter tank;
a layer of glass bead media overlaying said layer of gravel; and
intake means connected to said input port for distributing said ozone treated wastewater over said glass bead media to remove fine particulates from said ozone treated wastewater as said ozone treated wastewater flows from said input port to said output port.

9. The water reclamation system of claim 8 wherein said electrostatic filter means further comprises:
electrode means for applying an electric charge to said glass bead filtering media to cause fine particulates in said flow of pre-filtered wastewater to be electrostatically attracted to said glass bead media.

10. The water reclamation system of claim 9 wherein said electrostatic filter means further comprises:
automatic backwash means to clean collected fine particles from said glass bead media to rejuvenate said glass bead media.

11. A method of reclaiming waste water to remove odors, bacteria and particulates from a flow of wastewater to produce clean water for re-use, comprising:
ozonating a flow of wastewater to remove odors and bacteria;
pre-filtering said flow of ozone treated wastewater by separating heavier particulates out of said wastewater;
electrostatically filtering said flow of pre-filtered wastewater to remove finer particulates; and
storing cleaned water received from said step of electrostatic filtering in a holding tank for re-use.

12. The method of reclaiming waste water of claim 11 wherein said step of ozone generating comprises:
mechanically removing particulates from ambient air;
converting oxygen, contained in a flow of said filtered ambient air, into ozone in an ozonator apparatus to produce ionized, filtered air; and
injecting said ionized, filtered air into said flow of wastewater to remove odors and bacteria.

13. The method of reclaiming waste water of claim 12 wherein said step of converting comprises:
exposing said flow of said filtered ambient air to ultraviolet light to convert oxygen contained in a flow of said filtered ambient air into ozone.

14. The method of reclaiming waste water of claim 12 wherein said step of injecting comprises:
creating a pressure differential using a venturi to cause a suction to extract the ozone from said ozonator apparatus and inject the ozone into said flow of wastewater.

15. The method of reclaiming waste water of claim 11 wherein said step of pre-filtering comprises:
removing heavier particulates from said flow of ozone treated wastewater using a cyclonic mixer/filter.

16. The method of reclaiming waste water of claim 15 further comprising:
returning said ozone treated wastewater to atmospheric pressure in a process tank.

17. The method of reclaiming waste water of claim 16 further comprising:
mechanically pumping said ozone treated wastewater out of said process tank to electrostatically filter said ozone treated wastewater.

18. The method of reclaiming waste water of claim 11 wherein said step of electrostatically filtering comprises:
generating a flow of said ozone treated wastewater into a filter tank having input and output ports, a layer of gravel distributed in the bottom of said filter tank, a layer of glass bead media overlaying said layer of gravel and intake connected to said input port for distributing said ozone treated wastewater over said glass bead media to remove fine particulates from said ozone treated wastewater as said ozone treated wastewater flows from said input port to said output port.

19. The method of reclaiming waste water of claim 18 wherein said step of electrostatically filtering further comprises:
applying an electric charge to said glass bead filtering media to cause fine particulates in said flow of pre-filtered wastewater to be electrostatically attracted to said glass bead media.

20. The method of reclaiming waste water of claim 19 wherein said step of electrostatically filtering further comprises:
automatically backwashing said glass bead media to clean collected fine particles from said glass bead media to rejuvenate said glass bead media.
